(19) United States
(12) Patent Application Publication
(10) Pub. No.: US 2024/0400430 A1
(43) Pub. Date: Dec. 5, 2024

(54) MODULAR SYSTEM AND METHOD FOR TREATING SEPTIC TANK WASTEWATER USING SUBSTRATES THAT SUPPORT MULTIPLE BIOHABITATS

(71) Applicant: Entex Technologies, Inc., Chapel Hill, NC (US)

(72) Inventors: Wayne Josef Flournoy, Chapel Hill, NC (US); Lauren Alyssa Takitch, Raleigh, NC (US)

(21) Appl. No.: 18/676,671

(22) Filed: May 29, 2024

Related U.S. Application Data
(60) Provisional application No. 63/470,205, filed on Jun. 1, 2023.

(51) Int. Cl. C02F 3/30; C02F 103/00

(52) U.S. Cl. CPC C02F 3/301; C02F 2103/005; C02F 2203/008

(57) ABSTRACT

A modular system for treating septic tank wastewater using substrates that support multiple biohabitats is lowered into a septic system where untreated wastewater enters the system from an opening defined by the lower region, travels upwardly through a bioremediation chamber containing a substrate oriented to form at least one vertical path, and treated wastewater exits through an opening defined by the upper region. An aerator positioned below the lower opening sends a stream of bubbles upwardly, thereby urging untreated wastewater upwardly into the bioremediation chamber. A mixer positioned below the lower opening intermittently emits large air bubbles that dislodge biomasses that accumulate on the substrate. A variety of microbiological processes occur on the surfaces and within the recesses of the substrate.

### CROSS REFERENCE TO RELATED APPLICATION

This application claims the benefit of U.S. patent application 63/470,205 filed Jun. 1, 2023 entitled MODULAR SYSTEM AND METHOD FOR TREATING SEPTIC TANK WASTEWATER USING SUBSTRATES THAT

SUPPORT MULTIPLE BIOHABITATS, which is hereby incorporated by reference in its entirety.

### BACKGROUND OF THE INVENTION

### Field of the Invention

The present invention relates to wastewater treatment and more specifically, to portable microbe-driven treatment systems for septic systems.

### Description of the Prior Art

According to the Environmental Protection Agency, more than one in five households in the U.S. depend on individual systems or small community cluster systems, also known as “decentralized” systems, to treat their wastewater. These systems are used to treat and disperse relatively small volumes of wastewater, usually from houses and businesses located in suburban and rural locations not served by a public, or “centralized” sewer system.

If a decentralized system is properly installed, sited and maintained it can protect public health, preserve valuable water resources, and maintain economic vitality in a community. Decentralized systems such as septic systems are a cost-effective and long-term option for treating wastewater, particularly in less densely populated areas.

Septic systems are underground wastewater treatment structures that typically treat household wastewater produced by bathrooms, showers, kitchen drains and laundry. Referring to FIG. 1, known septic systems 75 generally receive untreated wastewater into first compartment 77 through input baffle 85. In the first compartment much of the solid matter is aggregated as sludge 83 and partially treated wastewater travels from that first compartment to second compartment 78 via internal baffle 86. In second compartment 78 additional solid matter is aggregated as sludge 83, and resulting wastewater is evacuated via output baffle 87 to the drain field 79. The treated water eventually enters the groundwater.

Unfortunately, septic systems don't always function properly, leading to issues including plumbing backups, leach fields that fail to evenly disperse effluent which leads to soggy and unpleasant ground, sluggish draining and foul odors. Remedies include pumping out the system and/or adding various enzymes, chemical agents and biologicals. Usually these fixes are temporary.

The Applicant has been a major contributor to growth media and module-based system technologies in centralized systems such as municipal wastewater treatment. More specifically, they have developed highly engineered growth media that facilitates the growth of microbial colonies to metabolize a broader scope of waste products than conventional growth media. Additionally, they have developed module-based systems to facilitate the treatment of not only centralized systems, but other wastewater bodies, for example lagoons. The Applicant's relevant patents listed herein are incorporated by reference in their entirety:
SYSTEM FOR TREATING WASTEWATER AND A CONTROLLED REACTION-VOLUME MODULE USABLE THEREIN, U.S. Pat. No. 7,445,715 B2, filed Nov. 22, 2005;
WASTEWATER TREATMENT METHOD, U.S. Pat. No. 7,854,843 B2, filed Mar. 8, 2010;
SYSTEM FOR TREATING WASTEWATER HAVING A CONTROLLED REACTION-VOLUME MODULE USABLE THEREIN, U.S. Pat. No. 7,691,262 B2, filed Oct. 13, 2008;
MEDIA FOR SUPPORTING GROWTH BIOLOGY WITHIN A WASTEWATER TREATING SYSTEM, United States Patent D718412 S1, filed Dec. 3, 2012;
EXTRUDED MEDIA FOR SUPPORTING GROWTH BIOLOGY WITHIN A WASTEWATER TREATING SYSTEM, United States Patent D618760 S1, filed Nov. 2, 2009;
MEDIA FOR SUPPORTING GROWTH BIOLOGY WITHIN A WASTEWATER TREATMENT SYSTEM, United States Patent D762279 S1, filed Nov. 24, 2014;
ANOXIC SYSTEM SCREEN SCOUR, U.S. Pat. No. 8,568,593 B1, filed Jun. 2, 2010;
EXTRUDED MEDIA FOR SUPPORTING GROWTH BIOLOGY WITHIN A WASTEWATER TREATING SYSTEM, United States Patent D672009 S1, filed Jun. 8, 2010;
SYSTEM AND METHOD FOR BIOLOGICALLY TREATING WASTEWATER USING LOW DENSITY, HIGH SURFACE AREA SUBSTRATES, U.S. Pat. No. 10,676,382, filed Sep. 28, 2018;
SYSTEM AND METHOD FOR BIOLOGICALLY TREATING WASTEWATER USING LOW DENSITY, HIGH SURFACE AREA SUBSTRATES, U.S. Pat. No. 11,254,593, filed May 14, 2020; and.
FLOTABLE SYSTEM AND METHOD FOR BIOLOGICALLY TREATING WASTEWATER USING LOW DENSITY, HIGH SURFACE AREA SUBSTRATES, U.S. Pat. No. 11,254,594, filed May 19, 2020.
THREE-DIMENSIONAL FABRIC MEDIA FOR USE WITH MOVING BED BIOFILM REACTORS AND SYSTEMS RELATED THERE TO, U.S. patent application Ser. No. 16/929,355, filed Jul. 15, 2020.

While both centralized and decentralized systems have some analogous structures and processes, and share the goal of remediating wastewater, they are unique systems that operate on vastly different scales and therefore present different challenges. Technological advances in centralized wastewater treatment, therefore, are not easily adapted for decentralized systems.

One of the biggest challenges of treating septic tank wastewater is access. The tank access of a standard septic tank is 24″ diameter. While this provides adequate access for adding or extracting matter, it is too small to receive known bioremediation module systems. A related issue is that substrates of known systems must be continuously and robustly agitated to dislodge biomass to prevent clogging the substrate's microhabitats, but employing a small mixer with a miniaturized system wouldn't provide adequate agitation, and a standard sized mixer would be too large to fit into a septic tank.

Another challenge is maintenance of the system. Homeowners don't generally have the knowledge or desire to practice routine maintenance on their septic system. Improper or inadequate maintenance is the leading cause of septic system problems, and creates costly, inconvenient and environmentally hazardous mishaps.

As can be seen there is a need for a septic tank treatment system that is powerful enough to be effective, yet small enough to be introduced into a standard septic tank. It is also desirable that this system is entirely or substantially maintenance-free, easy to use, and economically feasible.

### SUMMARY OF THE INVENTION

A modular system for treating septic tank wastewater using substrates that support multiple biohabitats is lowered into a septic system. Untreated wastewater enters the system from an opening defined by the lower region, travels upwardly through a bioremediation chamber containing a substrate oriented to form at least one vertical path, and treated wastewater exits through an opening defined by the upper region. An aerator positioned below the lower opening sends a stream of bubbles upwardly, thereby urging untreated wastewater upwardly into the bioremediation chamber. A mixer positioned below the lower opening intermittently emits large air bubbles or pulses that dislodge biomasses that accumulate on the substrate. A variety of microbiological processes occur on the substrate outer surfaces and within the recesses of the substrate. A method of using the system includes lowering the system through a septic tank's access, engaging an air supply and power supply to power the mixer, and allowing the system to treat wastewater within the tank.

### BRIEF DESCRIPTION OF THE DRAWINGS

FIG. 1 depicts a septic system of the prior art;

FIG. 2 depicts a septic system of the present invention;

FIG. 3 depicts a perspective view of a treatment system of the present invention;

FIG. 4 depicts a perspective view of a treatment system of the present invention with some internal structures shown in phantom;

FIG. 5 depicts a top view of a substrate housing with the substrate within in a spiral orientation;

FIG. 6 depicts a top view of a substrate housing with the substrate within in a serpentine orientation;

FIG. 7 depicts a perspective view of an aerator discharging bubbles;

FIG. 8 depicts a perspective view of mixer emitting an air pulse;

FIG. 9 depicts a mixer discharging an air pulse below a substrate;

FIG. 10 depicts a front view of the top surface of a substrate;

FIG. 11 depicts a front view of a substrate showing multiple surface layers;

FIG. 12 depicts is a side view of a substrate, showing one layer of interconnecting fibers;

FIG. 13 depicts a side view of a substrate, showing multiple layers of interconnecting fibers;

FIG. 14 depicts a close-up top view of a segment of substrate; and

FIG. 15 schematically depicts some metabolic processes taking place on a substrate.

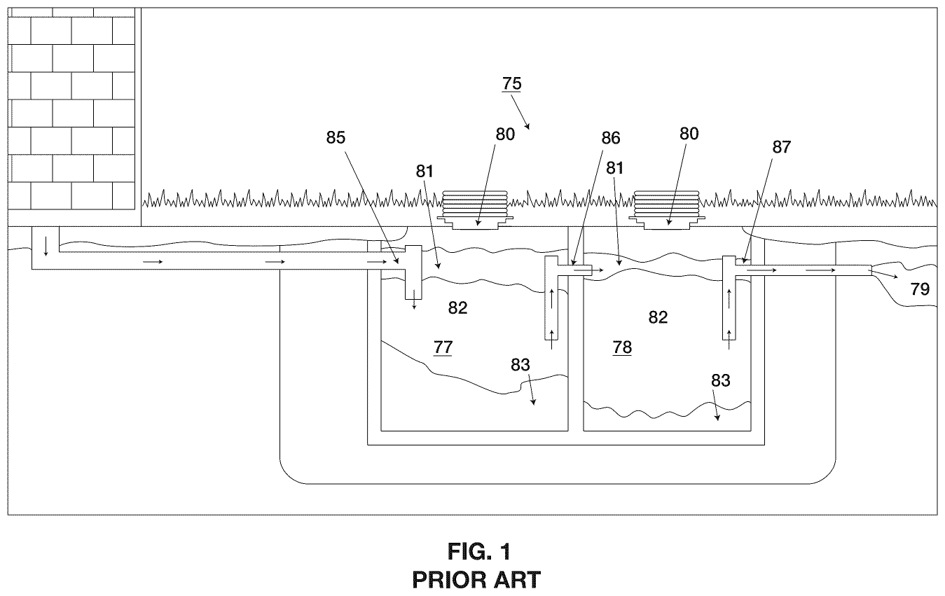

### DETAILED DESCRIPTION OF THE INVENTION

As used herein, the following structure numbers shall refer to the various structures of the invention as depicted in the figures:
10—Treatment system;
13—Influent;
15—Effluent;
17—Liquid flow;
20—Bioremediation chamber;
22—Substrate housing;
24—Upper opening;
25—Upper support;
27—Lower opening;
28—Lower support;
30—Substrate;
31—Substrate surface;
32—Interconnecting fiber;
33—Aerobic zone;
34—Anoxic zone;
35—Vertical path;
36—Microbes;
37—Biomass;
40—Retrieval line;
45—Float;
50—Aerator;
51—Bubbles;
55—Mixer;
56—Air pulse;
57—Accumulator plate;
60—Weight;
65—Air supply;
70—Power supply;
75—Septic system;
77—First compartment;
78—Second compartment;
79—Drain field;
80—Tank access;
81—Scum;
82—Wastewater;
83—Sludge;
85—Input baffle;
86—Internal baffle; and
87—Output baffle.

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

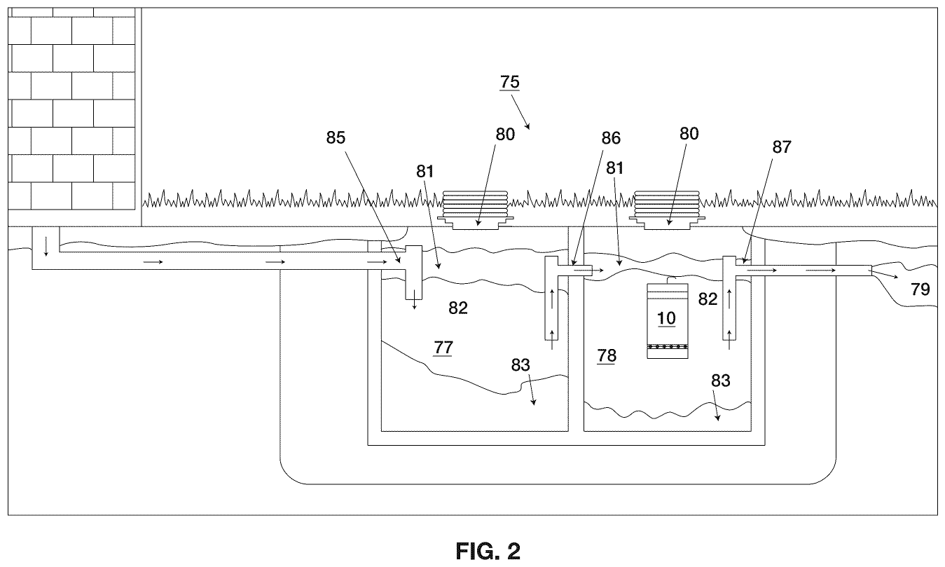

Referring to FIG. 2, septic system 75 of the present invention includes first compartment 77, in fluid communication with second compartment 78. Tank accesses 80 provides access to the compartments and are generally approximately 24 inches in diameter. Treatment system 10 is inserted into at least one of the compartments, here shown inserted into second compartment 78 through access port 80. In a preferred embodiment the total width of treatment system 10 is approximately 20 inches, thereby allowing easy insertion into conventional septic systems through conventional tank access ports. As shown in FIG. 2, treatment system 10 is below the surface of the liquid, and beneath the scum, but it should be understood that the system can be positioned higher or lower than shown, including resting on the bottom surface of the tank compartment.

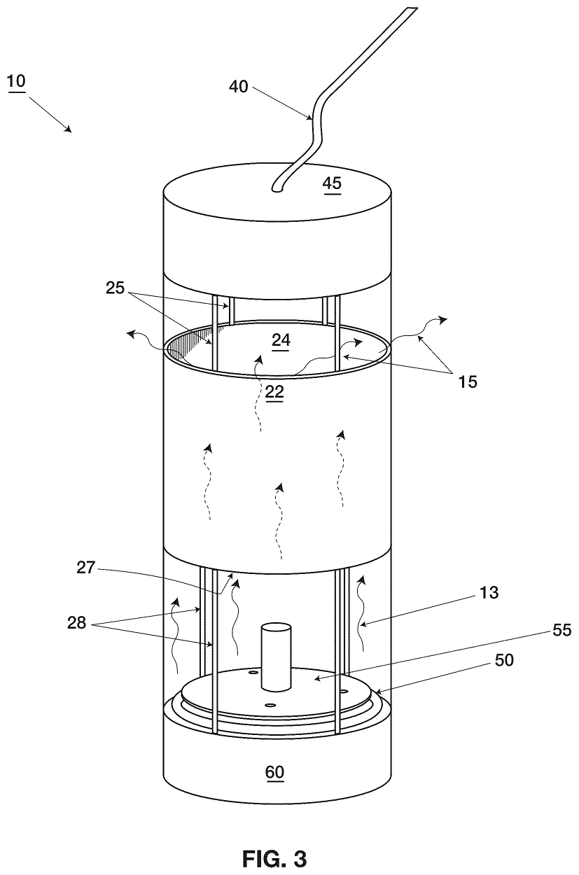

FIG. 3 depicts some major components of treatment system 10. From top to bottom, components preferably include retrieval line 40 or other means which allows a user to remove the system from a septic tank by grasping the retrieval line and pulling it through the tank access. A preferred embodiment includes float 45 which generally holds the treatment system at the desired depth in the compartment. Below the float is a plurality of upper supports 25 which connect the float to substrate housing 22. Substrate housing 22 and substrate 30 within, which is not shown in this figure, collectively form bioremediation chamber 20. Beneath substrate housing 22 is a plurality of lower supports 28 which connect substrate housing 22 to a base, preferably weight 60. The base, or weigh 60, supports aerator 50 and mixer 55. In an alternative embodiment supports 28 may connect directly with aerator 50 and/or mixer 55, with or without a base or weight 60. In a preferred embodiment, upper and lower supports 25, 28 are rigid, for example bars, and allow the free flow of liquid in and out of substrate housing 22. As demonstrated by arrows, liquid generally enters substrate housing 22 through lower opening 27, travels upwardly through substrate housing 22, and exits the system through upper opening 24. As used herein, wastewater entering the substrate housing at the lower opening 27 is influent 13, while wastewater exiting the substrate housing at the upper opening 24 is effluent 15.

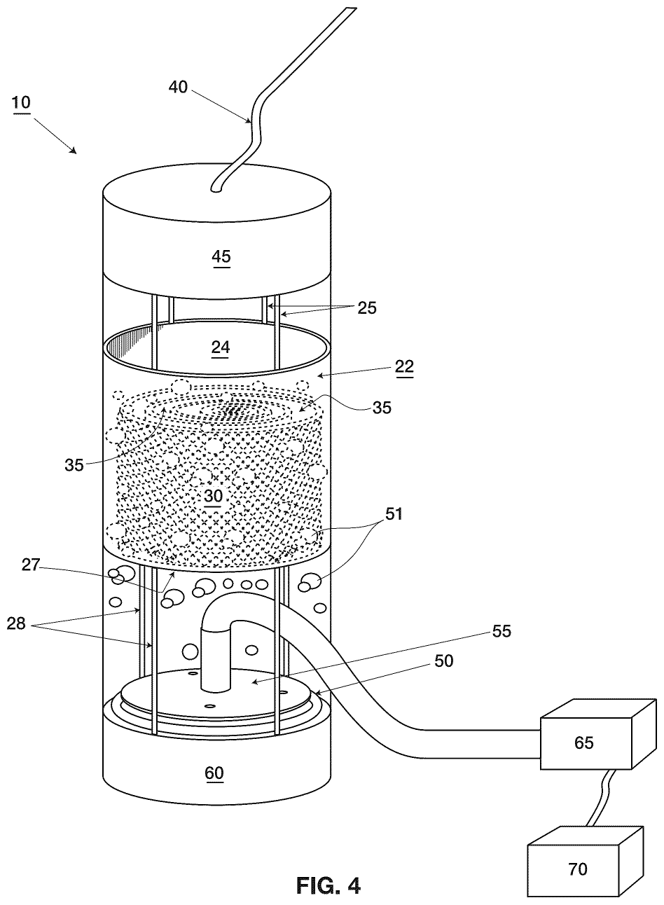

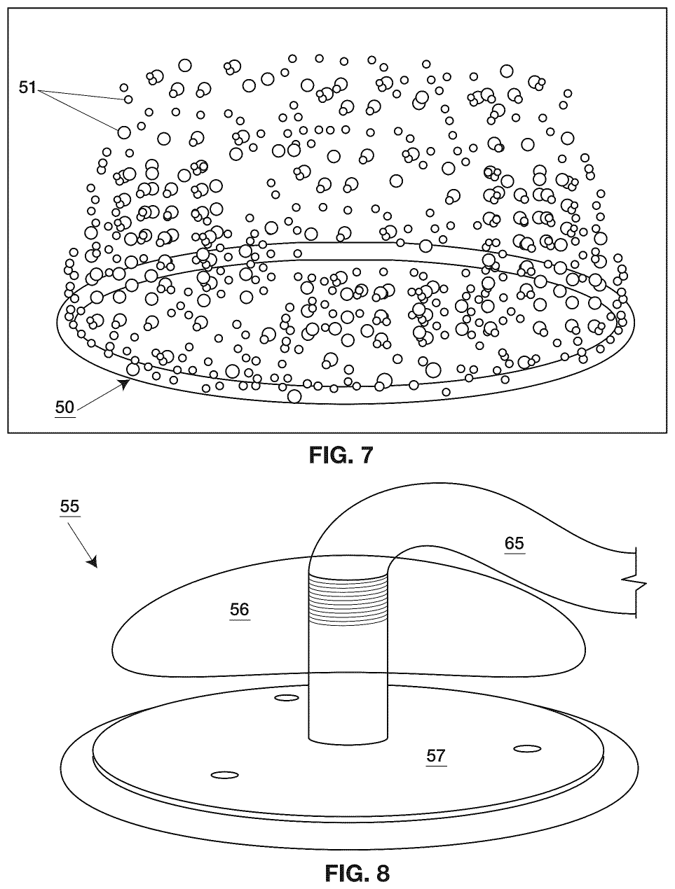

Referring to FIG. 4, substrate housing 22 is preferably tubular with open ends, namely the upper end of substrate housing defining upper opening 24, while the lower end defining lower opening 27. This shape is consistent with the preferred generally cylindrical and elongated shape of the overall system, which lends itself to insertion and removal through conventional septic tank accesses, although other shapes are within the scope of the invention. Substrate housing may be solid or foraminous, and may be constructed of plastic or metal. For purposes of illustration FIG. 4 depicts substrate 30 but it should be understood that the substrate is within the housing and would not be visible in use. Aerator 50, a preferred embodiment of which is depicted in FIG. 7, generates bubbles 51 in a variety of sizes to oxygenate the water for the benefit of microbes 36 (not shown) on and in the substrate. Mixer 55, a preferred embodiment of which is depicted in FIG. 8, emits intermittent air pulses 56. Alternatively, mixer could be pump injection of air or water, or a mechanical mixer. Air supply 65, for example an air compressor, supplies air to aerator 50 and mixer 55. Power supply 70 powers the air supply.

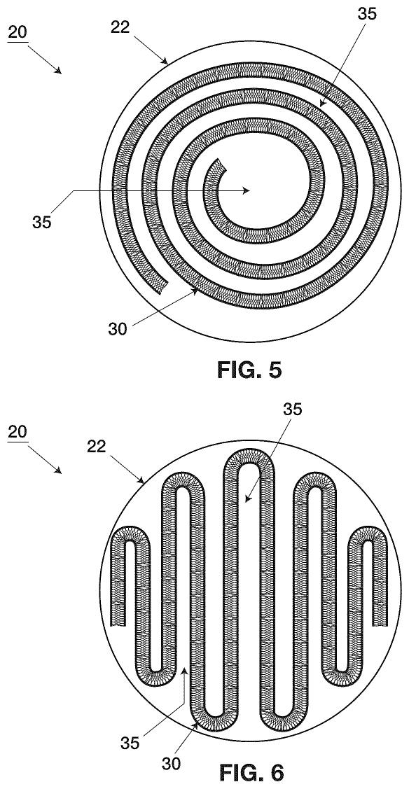

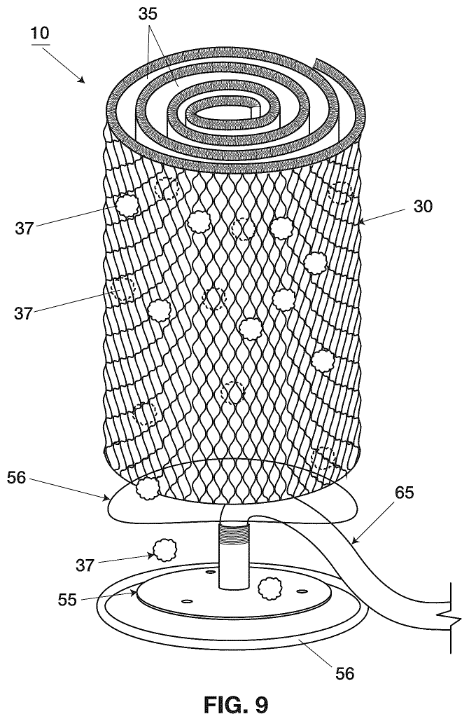

The substrate is preferably a sheet such as that disclosed in Entex Patent D762279 which is buoyant and only requires fixing on one axis, and can be positioned in the substrate housing in a variety of ways. FIG. 5 depicts a top view of substrate 30 in a spiral configuration within substrate housing 22, while FIG. 6 depicts a top view of substrate 30 in a serpentine configuration within housing 22. These configurations are desirable because they each provide at least one vertical path 35 through which bubbles and fragments of air pulses can travel upwardly, and through which sloughed accumulations of biomass 37, best shown in FIG. 9, can travel downwardly. Preferably a vertical path is substantially unimpeded for the entire length insofar as bubbles and/or biomass can freely travel upwardly or downwardly, respectively, without getting trapped in route. While spiral and serpentine configurations are desirable, other configurations are also within the scope of this invention, with configurations which result in at least one vertical path 35 being preferred.

Referring to FIG. 7, a preferred aerator 50 is a Large Bubble Mixing System from Pulsair Systems, Inc. of Bellvue, WA. Referring to FIG. 8, a preferred mixer 55 is an Aero-Tube hose diffuser from Swan Products LLC of Sandy Springs, GA.

As shown in FIG. 9, mixer 55 emits intermittent air pulse 56. This air pulse provides adequate force to dislodge biomasses 37 from substrate 30. It is a key feature of this invention that biomasses are periodically sloughed off the substrate in order to prevent overgrowth and clogging the microhabitats. It is important to note that air pulse 56 does not significantly aerate the microbes, as microbes metabolize oxygen that is dissolved in water, not in air. Biomass 37 that drops off the substrate travels downwardly, preferably via vertical paths 35, and settles on the bottom of the tank alongside other particulates.

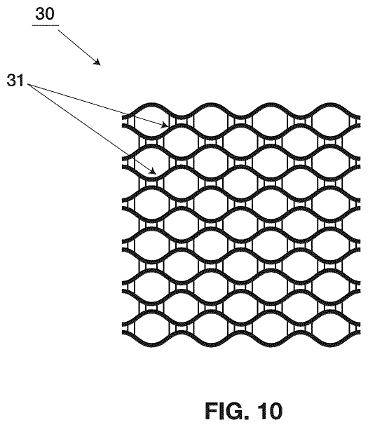

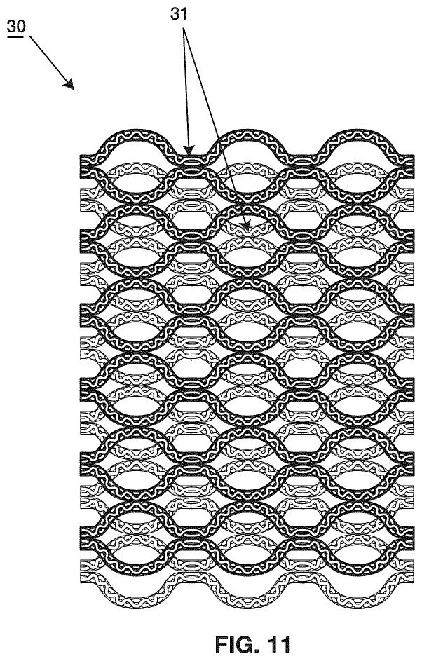

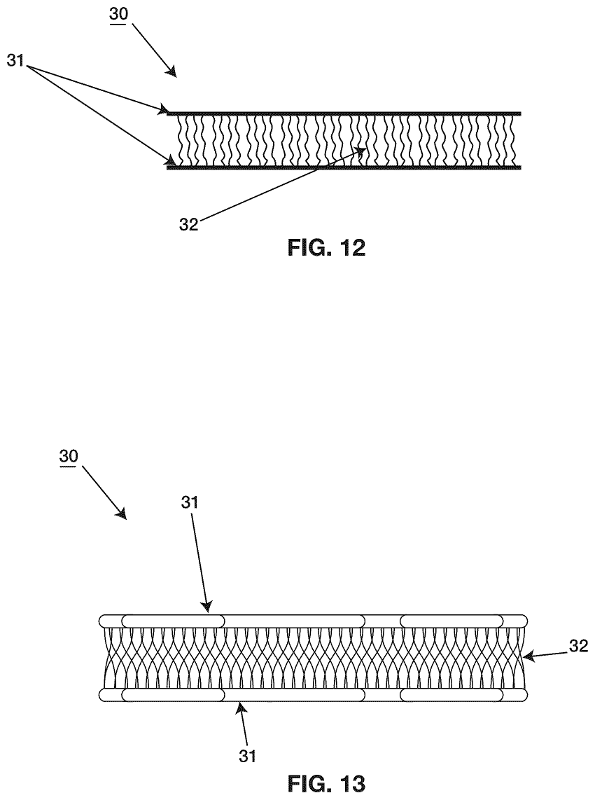

FIG. 10 is a segment of preferred substrate 30, including substrate surface 31 formed by the outside material. This is also shown in FIG. 11. FIG. 12 is a side view of the segment of preferred substrate 30 from FIG. 10, including substrate surfaces 31 and interconnecting fibers 32 which are between and connect the surfaces. This is also depicted in FIG. 13. In a preferred embodiment substrate 30 includes two opposing substrate surfaces which are substantially identical.

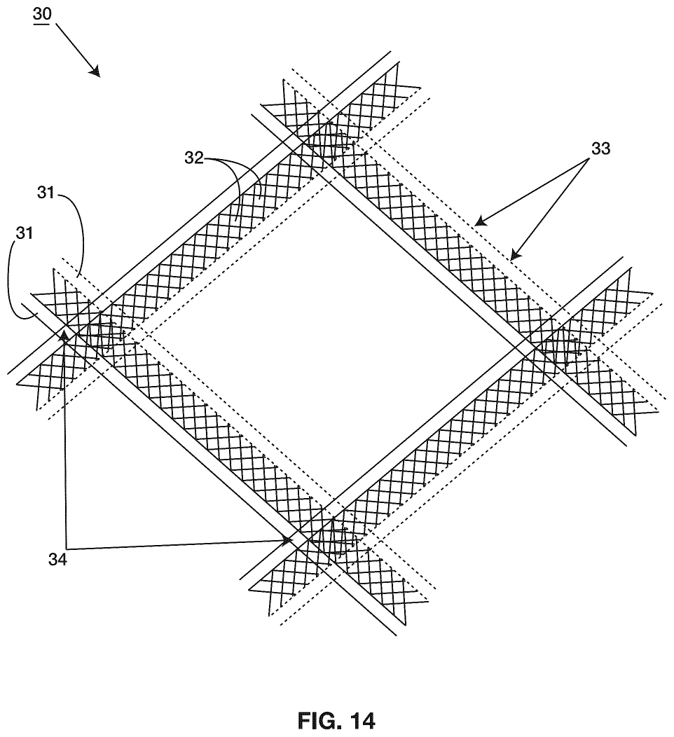

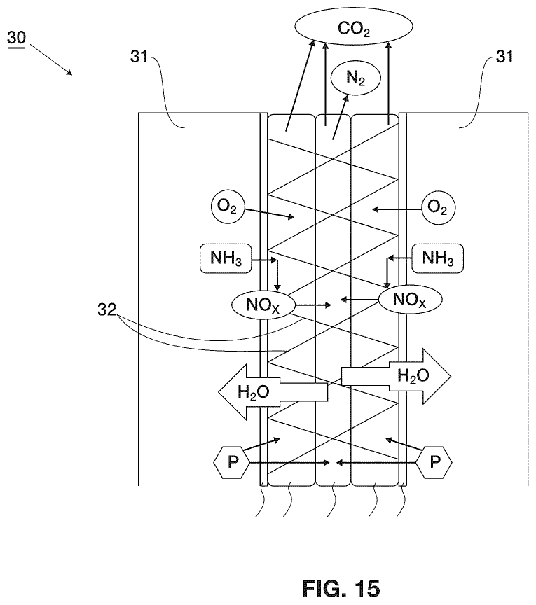

The various microhabitats formed by the “diamond” segments of substrate 30 are depicted in FIG. 14. Substrate surfaces 31 allow gas, nutrient and food diffusion, while areas surrounded by substrate material, for example where edges of diamonds meet and deep within the interconnected fibers, are less permeable to gas, nutrient and food diffusion. This steep and sustained gradient of oxygen concentration within the substrate creates both aerobic zones 33 and anoxic zones 34, thereby supporting both aerobic and anaerobic microbes, and simultaneous nitrification and denitrification. It is noted that these metabolic activities essentially mimic the desirable action of anammox bacteria, but without the challenges associated with maintaining viable anammox colonies. The various metabolic processes that take place on aerobic substrate surfaces 31 and anoxic interconnecting fibers 32 are schematically depicted in FIG. 15.

In use, treatment system 10 of the present invention is connected to air supply 65, and parameters such as flow rate of aerator 50 and pulse speed of mixer 55 are adjusted in accordance with the needs of the specific tank. The system is inserted through tank access 80 into the tank of a conventional septic system 75 and allowed to run, which leads to colonization of substrate 30 by various microbes 36, and treatment of wastewater by those microbes. The system may be periodically removed from the septic tank by pulling the unit out using retrieval line 40, and can be examined to ensure the integrity of the substrate and to confirm proper functioning of subsystems such as the aerator and mixer.

It should be understood that the foregoing relates to exemplary embodiments of the invention and that modifications may be made without departing from the spirit and scope of the invention as set forth in the following claims. By way of example, modifications within the scope of this invention include different means of mixing, different means of aerating, and different means of fixing or configuring media in the substrate housing. Terms such as “substantially” and the like shall mean within reasonable bounds when considering limitations such as machines, materials, manufacturing methods, and people. By way of example, a “substantially smooth” surface means there are no intentional bumps or irregularities. All ranges set forth herein include the endpoints as well as all increments there between, even if not specifically stated. By way of example 1 to 2 inches includes 1 inch, 1.000001 inches and so forth. Finally, unless otherwise stated or contrary to common sense, “approximate” and the like shall mean+/−10%.

What is claimed is:

1. A wastewater treatment system comprising:
a. A bioremediation chamber including a substrate configured to form at least one vertical path;
b. An aerator positioned below said bioremediation chamber, said aerator emitting bubbles that enter at least one of said vertical paths;
c. Colonies of microbes supported by said substrate, said colonies forming a plurality of biomasses; and
d. A mixer positioned below said substrate, said mixer emitting air pulses that dislodge some of said biomasses, wherein said system is less than 24″ wide.

2. The wastewater treatment system of claim 1 wherein said substrate includes a first substrate surface connected to an opposing second substrate surface, said first surface and said second substrate surface substantially identical.

3. The wastewater treatment system of claim 2 wherein said first substrate surface and said second substrate surface are connected one to the other by a plurality of interconnecting fibers.

4. The wastewater treatment system of claim 3 wherein said substrate forms an oxygen concentration gradient with the highest concentration of oxygen adjacent said first substrate surface and said second substrate surface, and the lowest concentration of oxygen adjacent said interconnecting fibers.

5. The wastewater treatment system of claim 1 wherein said substrate includes aerobic zones and anoxic zones.

6. The wastewater treatment system of claim 1 wherein said substrate is configured into an orientation selected from the group consisting of spiral, serpentine, and combinations thereof.

7. The wastewater treatment system of claim 1 wherein at least one of said vertical paths is substantially unimpeded for its entire length.

8. A septic system comprising:
a. A compartment for receiving wastewater, said compartment defining a tank access; and
b. A treatment system positioned within said compartment, said treatment system sized and shaped for insertion into said compartment through said tank access and including a bioremediation chamber having a substrate that simultaneously supports aerobic and anaerobic microbes.

9. The septic system of claim 8 wherein said substrate includes a first substrate surface connected to a second substrate surface by a plurality of interconnecting fibers.

10. The septic system of claim 8 wherein said substrate is configured to form at least one substantially unimpeded vertical path.

11. The septic system of claim 10 wherein said substrate is configured into an orientation selected from the group consisting of spiral, serpentine, and combinations thereof.

12. The septic system of claim 8 wherein said treatment system further includes a mixer positioned below said substrate.

13. The septic system of claim 12 wherein said mixer emits discrete air pulses.

14. The septic system of claim 13 wherein said air pulses dislodge biomasses of said microbes.

15. A system of treating wastewater in a septic system including the steps of:
a. Lowering a wastewater treatment system into a compartment of a septic system through said compartment's tank access;
b. Initiating airflow into an aerator located in the lower region of said wastewater treatment system;
c. Allowing air from said aerator to travel upwardly through at least one vertical path defined by a substrate within said wastewater treatment system;
d. Allowing aerobic and anaerobic microbes to colonize said substrate; and
e. Removing said wastewater treatment system from said compartment through said tank access.

16. The method of treating wastewater in a septic system according to claim 15 further including the step of initiating airflow into a mixer located in the lower region of said wastewater treatment system.

17. The method of treating wastewater in a septic system according to claim 16 further including the step of allowing air from said mixer to travel upwardly through said at least one vertical path.
